(19) United States
(12) Patent Application Publication
(10) Pub. No.: US 2017/0154350 A1
(43) Pub. Date: Jun. 1, 2017

(54) METHOD, SYSTEM, AND PROGRAM PRODUCT FOR AUTOMATICALLY GENERATING SWEEPSTAKES REWARDS

(71) Applicant: Retail Gaming Solutions, LLC, Troy, FL (US)

(72) Inventors: Jeffrey Stevens Perlee, Altamont, NY (US); Scot Schechner, Saratoga, NY (US); Henry Cumoletti, Guilderland, NY (US); Nick Stefani, Key West, FL (US)

(21) Appl. No.: 15/366,710

(22) Filed: Dec. 1, 2016

Related U.S. Application Data
(60) Provisional application No. 62/261,764, filed on Dec. 1, 2015.

(51) Int. Cl. G06Q 30/02; G07F 17/32; G06Q 10/08

(52) U.S. Cl. CPC G06Q 30/0212; G06Q 10/087; G07F 17/3244; G07F 17/329

(57) ABSTRACT

Embodiments of the present disclosure provide methods, systems, and program products for autoamtically generating sweepstakes rewards. A method according to the present disclosure can include: pairing a sweepstakes token with a user profile stored in an electronic data processing system operated by an administrator independent from a sweepstakes administrator; generating a user prize inventory for the user profile using a selection of prizes from a master inventory, a user-generated inventory, and an inventory of a different user profile; in response to the token being a winning token, purchasing at least one eligible prize from the user prize inventory and deducting a cost of the at least one eligible prize from a sweepstakes monetary reward; and in response to the token being a non-winning token, generating at least one coupon for an eligible prize based on the user prize inventory.

### BACKGROUND

The present disclosure relates generally to process methodologies for automatically generating sweepstakes rewards or incentives to consumers who provide a winning and/or non-winning token. Specifically, the present disclosure provides methods, systems, and program products for automatically generating one or more sweepstakes rewards based on a particular-real world transaction in which a consumer enters into a sweepstakes.

For entertainment and/or the prospect of financial gain, a consumer can enter as a participant in a game of chance, e.g., a state-sponsored or private lottery, raffle, casino game, etc., identified collectively herein as a “sweepstakes.” Typically, a customer can enter a sweepstakes through an online portal, or by completing a transaction at a retail site or point of service. To increase the amount of interest or customer participation on a sweepstakes, state lotteries and/or individual retailers may offer incentives programs, e.g., rewards point accounts, second chance drawings, etc., to increase the value of repeat participation in a sweepstakes by a consumer. However, many of these state-specific or retailer-specific incentives programs can carry inherent limitations. For example, a consumer's account may have limited use or no use at other retailers and/or within other states. Thus, a consumer who travels frequently or moves from one area to another may not be able to transfer an existing account for an incentive program because it is not offered in the new location. In addition, the value of a sweepstakes may be unclear even when some sweepstakes programs offer significant financial rewards as compared to other sweepstakes programs.

### SUMMARY

A first aspect of the present disclosure provides a computer-implemented method for automatically generating a sweepstakes reward. The method can include: pairing a sweepstakes token with a user profile stored in an electronic data processing system operated by an administrator independent from a sweepstakes administrator; generating a user prize inventory for the user profile using a selection of prizes from a master inventory, a user-generated inventory, and an inventory of a different user profile; in response to the token being a winning token, purchasing at least one eligible prize from the user prize inventory and deducting a cost of the at least one eligible prize from a sweepstakes monetary reward; and in response to the sweepstakes token being a non-winning token, generating at least one coupon for an eligible prize based on the user prize inventory.

A second aspect of the present disclosure provides a program product stored on a computer readable storage medium, and operable to automatically generate a sweepstakes reward when executed. The computer readable storage medium can include program code for: pairing a sweepstakes token with a user profile stored in an electronic data processing system operated by an administrator independent from a sweepstakes administrator; generating a user prize inventory for the user profile using a selection of prizes from a master inventory, a user-generated inventory, and an inventory of a different user profile; in response to the token being a winning token, purchasing at least one eligible prize from the user prize inventory and deducting a cost of the at least one eligible prize from a sweepstakes monetary reward; and in response to the token being a non-winning token, generating at least one coupon for an eligible prize based on the user prize inventory.

A third aspect of the present disclosure provides a system for automatically generating a sweepstakes reward. The system can include: an account management system for pairing a sweepstakes token with a user profile stored in an electronic data processing system operated by an administrator independent from a sweepstakes administrator; and a transacting agent including program code for: generating a user prize inventory for the user profile using a selection of prizes from a master inventory, a user-generated inventory, and an inventory of a different user profile, in response to the token being a winning token, purchasing at least one eligible prize from the user prize inventory and deducting a cost of the at least one eligible prize from a sweepstakes monetary reward, and in response to the token being a non-winning token, generating at least one coupon for an eligible prize based on the user prize inventory.

### BRIEF DESCRIPTION OF THE DRAWINGS

These and other features of the disclosed apparatus will be more readily understood from the following detailed description of the various aspects of the apparatus taken in conjunction with the accompanying drawings that depict various embodiments of the invention, in which:

FIG. 1 is a schematic diagram of a consumer gaming rewards system according to an embodiment of the disclosure.

FIG. 2 is an illustrative environment which includes a computer system for implementing embodiments of the present disclosure.

FIG. 3 is a perspective view of a transacting agent operatively connected to an account management system according to embodiments of the present disclosure.

FIG. 4 is a flow diagram of an example method according to an embodiment of the disclosure.

It is noted that the drawings are not necessarily to scale. The drawings are intended to depict only typical aspects of the disclosure, and therefore should not be considered as limiting its scope. In the drawings, like numbering represents like elements between the drawings.

### DETAILED DESCRIPTION

In the following description, reference is made to the accompanying drawings that form a part thereof, and in which is shown by way of illustration specific exemplary embodiments in which the present teachings may be practiced. These embodiments are described in sufficient detail to enable those skilled in the art to practice the present teachings and it is to be understood that other embodiments may be utilized and that changes may be made without departing from the scope of the present teachings. The following description is, therefore, merely exemplary.

Embodiments of the disclosure also include processes for automatically generating sweepstakes rewards, for winning and non-winning tokens submitted by consumers. The processes described herein can be independent from the sweepstakes and/or its administrator(s), such that consumers can receive sweepstakes rewards tailored to their personal interests, as reflected in a user profile, for winning and/or entering the sweepstakes. In addition, embodiments of the present disclosure can include or otherwise draw functionality from one or more real-world transactions between the consumer, a sweepstakes administrator, and/or one or more third parties. Embodiments of the present disclosure can offer lottery consumers the opportunity to accept prizes or incentives offered by a sweepstakes administrator and/or third party based on a complete record of their previous activity as lottery or gaming consumers, without being limited by a specific lottery, retail establishment, and/or retailer-offered lottery rewards program.

Embodiments of the present disclosure can include pairing a sweepstakes token with a user profile stored in an electronic data processing system operated by a party independent from a sweepstakes administrator. For example, a point of sale (POS) terminal can automatically scan and recognize a sweepstakes token as being submitted by a particular user, and can then pair the token with a user profile associated with the consumer and stored in an electronic data processing system. After pairing the sweepstakes token with a user profile, a user prize inventory can be generated for the user profile using a selection, by the consumer, of prizes from a “master inventory,” i.e., a listing of rewards which is non-specific to individual users, a user-generated inventory (e.g., a personal wish list of prizes based on inputs reflecting the user's observations and interests), and an inventory of a different user profile. Where the user's sweepstakes token is a winning token (e.g., a code which matches one or more predetermined winning codes), the data processing system can automatically purchase items in the user prize inventory one or more associated suppliers, and deduct a cost of the purchased prizes from a monetary reward for the sweepstakes. Where applicable, the purchase price of the purchased items can be discounted to encourage participation in and use of the systems and methods described herein. Where the user's token is a non-winning token, the data processing system can generate at least one coupon (e.g., a redeemable discount or other purchase incentive) for an eligible prize included within the user prize inventory.

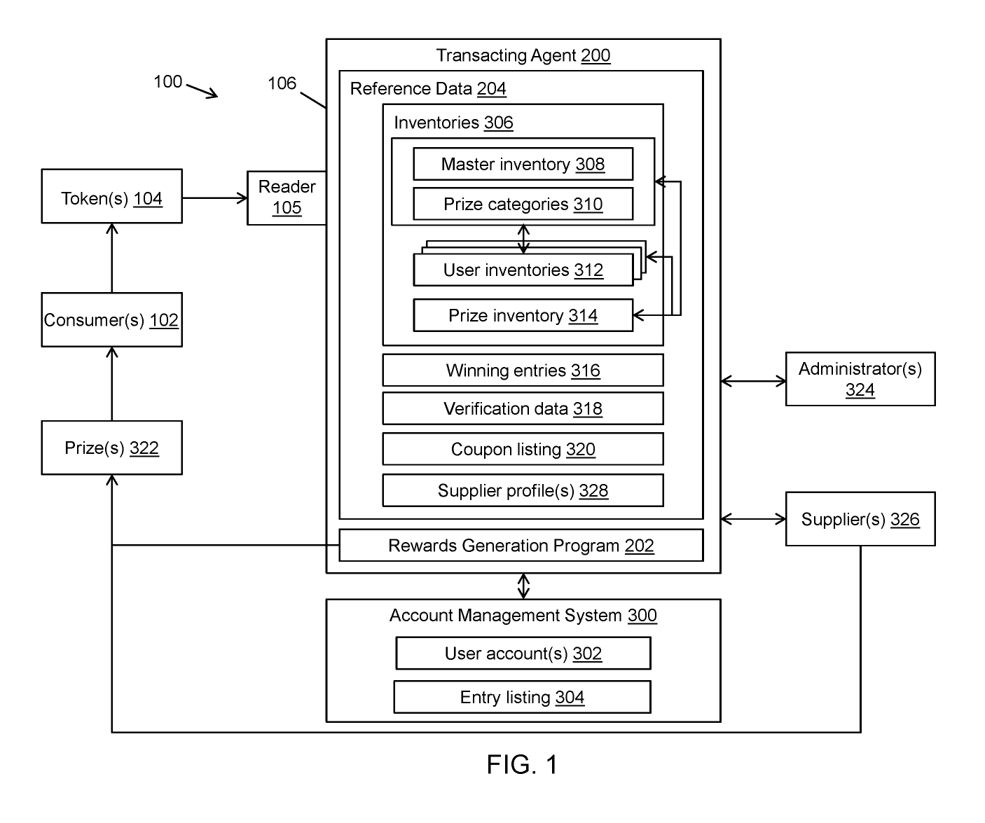

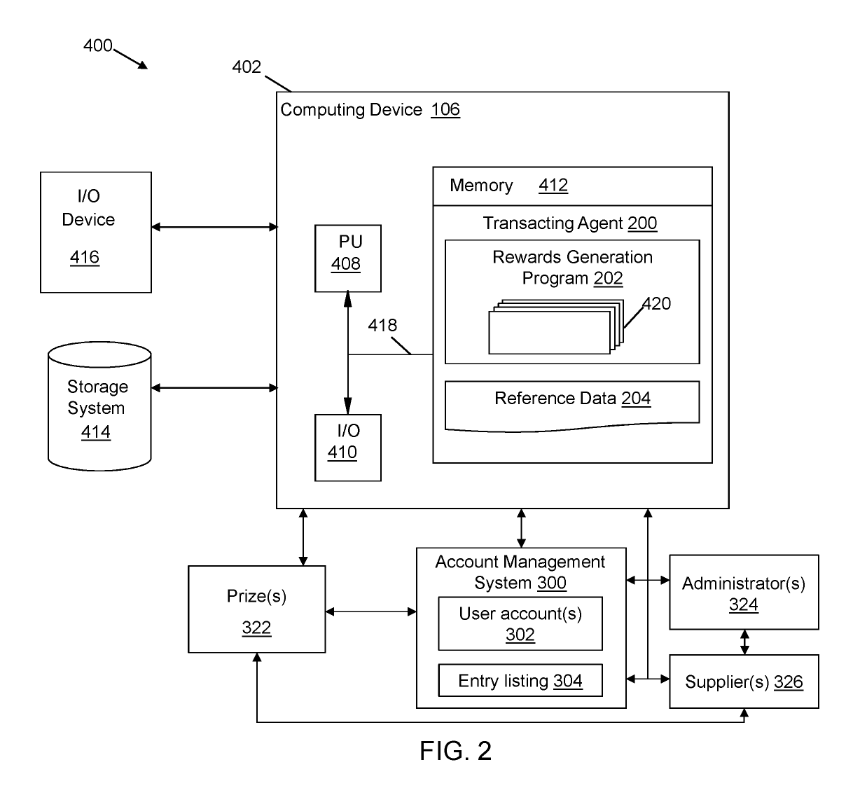

Referring to FIG. 1, an organizational diagram of a sweepstakes system 100 according to embodiments of the present disclosure is shown. To initiate process flows and functions described herein, a consumer 102 can tender one or more sweepstakes tokens 104 directly to transacting agent 200 and/or through a reader 105 in the form of, e.g., a personal digital device (e.g., PC, phone, tablet, etc.), an optical scanner at a point of sale (POS) terminal. Token(s) 104 can also be submitted to transacting agent 200 or by one or more other remote and/or in-person means (e.g., by mail, phone, manual entry, etc.). A computer system 106 including a transacting agent 200 therein can receive sweepstakes tokens 104 from consumer 102 (e.g., by scanning, manual entry of codes into an electronic data processing system, and/or other mechanisms) to initiate processes according to the present disclosure. An illustrative environment for implementing embodiments of the present disclosure, and including computer system 106, is discussed in detail elsewhere herein by reference to FIG. 2. Transacting agent 200 can include a rewards generation program 202 for executing processes according to the present disclosure, in addition to reference data 204 which can inform and/or modify the processing steps described herein.

Transacting agent 200 can be in communication with an account management system 300, e.g., through any currently known or later developed form of wired and/or wireless network connection, and/or combinations thereof. Account management system 300 can be stored in a data processing system (e.g., the same as or similar to such as a computer system 106) and/or within an independent database. A user account 302 can further be saved within account management system 300, or can be copied/read from a separate electronic database (not shown) in communication with account management system 300.

As discussed elsewhere herein, computer system 106 can include a reward generation program 202 for executing steps (e.g., reading and/or writing data in) related to user accounts and/or reference data 204. It is therefore understood that some steps and functions performed herein can be performed with software instructions of reward generation program 202. Consumer 102 can register for and/or log into user account 302, e.g., by connecting to a website or visiting a place of service where consumer 102 can access transacting agent 200. In an illustrative example, consumer 102 can create user account 302 manually through computer system(s) 106 available at a particular retail site or point of service, such as a grocery store, convenience store, etc. Consumer 102 can access, e.g., inventories 306 including a master inventory 308 and/or prize categories 310. Master inventory can provide a complete listing of redeemable prizes (e.g., products, services, discounts, subscriptions, purchase incentives, package deals, etc.) available through and/or suggested by the operator of the sweepstakes and/or third parties. Prize categories 310 can organize the prizes within master inventory 308, such that consumers 102 can more easily find and search through options within inventories 306 which are of greater interest. In embodiments of the invention, consumer 102 can access user account 302 in multiple ways, including, e.g., online with a browser or dedicated application on a computer (e.g., computing device 106, transacting agent 200, and/or account management system 300), tablet, phone, electronic kiosk, or other device that includes an internet connection, which can be owned personally by consumer 102 and/or by a retailer or rewards program operator.

As discussed herein, reward generation program 202 can be operable to generate a group of user inventories 312 based on, e.g., an automatic or manual selection from master inventory 308, prize categories 310, manual entry, and/or selection from other sources, provided by consumer 102 and/or reward generation program 202. User inventories 312 can be combined or modified to create a prize inventory 314, e.g., a single list of prizes available for redemption through reward generation program 202. In an embodiment, user inventories 312 can represent listings of desired prizes by category or event, while prize inventory 314 can apply to a particular time or sweepstakes.

In some cases, consumer(s) 102 may desire prize(s) 322 not provided in master inventory 308 and/or within prize categories 310. To compensate for possible shortcomings, transacting agent 200 can provide additional features to expand upon the coverage of prize categories 310 and/or master inventories 308. For example, reward generation program 202 can allow consumer(s) 102 to view (e.g., through a user interface of a social networking system or other account portal) prize inventories 314 of other consumer(s) who use sweepstakes system 100. Through this functionality, transacting agent 200 can generate prize inventories 314 which include selections from master inventory 308 and/or user inventories 312 from other consumer(s), thereby providing transacting agent 200 with a more complete understanding of interests, goals, etc., of each consumer 102, regardless of whether a particular sweepstakes has not yet begun, is ongoing, or has completed. In addition or alternatively, a user can generate one or more personal user inventories 312 based on, e.g., personal interests, observations or past experiences in one or more marketplaces, advertisements or offers, etc. One or more items from the generated user inventory 312 can then be transferred to prize inventory 314, e g , manually by the user and/or automatically by reward generation program 202. As such, prize inventory 314 can aggregate one or more of master inventory 308, user inventories 312 from other users, and/or user-generated user inventories 312.

For a particular sweepstakes or group of sweepstakes, reward generation program 202 can compare sweepstakes tokens 104 with data for winning tokens 316 (e.g., a listing of winning entry numbers, serial numbers, and/or other types of information designating a “win” by consumer 102). In addition, reward generation program 202 can provide processes and/or functions for verifying whether sweepstakes tokens 104 from consumer 102 are genuine. For example, reference data 204 can include verification data 318 for verifying whether, e.g., a serial number or other information for sweepstakes token 104 is genuine or fraudulent. Reward generation program 202 can determine whether each sweepstakes token 104 is genuine by comparing details thereof with verification 318 and/or implementing any currently known or later developed verification technique. Reference data 204 can also include a listing of coupons (“coupon listing” 320) which may correspond to master inventory 308, user inventories 312, and/or prize inventory 314. For example, coupon listing 320 can include authorized and/or available coupons which can be generated to consumer 102 following the receipt and/or verification of sweepstakes tokens 104. More particularly, reward generation program 202 can automatically or semi-automatically (i.e., with input from consumer 102) select coupons from coupon listing 320 to generate in the event that reward generation program 202 executes processes for the providing of coupons.

According to embodiments of the disclosure, user account(s) 302 can track sweepstakes transactions in several different states and/or countries, with the same user account 302 offering incentives to consumer 102 regardless of where he or she chooses to participate in other sweepstakes and/or independent rewards programs. Similarly, user account 302 can record transactions or activities by consumer 102 at different retail locations and franchises. Transacting agent 200 and/or account management system 300 in embodiments of the present disclosure may be offered in partnership with retailer-specific or state-specific loyalty programs, or may be completely independent of other sweepstakes rewards programs.

To provide prizes 322 and/or other incentives for creating and accessing user account 302, account management system 300 can allow one or more sweepstakes administrators 324 to exchange data with transacting agent 200, one or more suppliers 326, and/or third parties. More specifically, administrator(s) 324 can access and/or administer independent data processing systems, transacting agent(s) 200 of computing device 104. Each administrator 324 can operate, e.g., a government-specific or state-specific sweepstakes, a retailer-specific sweepstakes, a company-specific sweepstakes, a sweepstakes within a particular establishment such as a casino, etc. Regardless of whether each administrator 324 represents a separate entity, embodiments of sweepstakes system 100 can offer consumer(s) 102 the ability to receive prizes 322 for each independently operated (e.g., by different administrators 324) sweepstakes in which he or she participates. For simplicity, references to administrators 324 can also be construed as referring to data processing systems owned and/or operated by these entities. In addition, administrator(s) 324 can include one or more parties who maintain account management system 300 and/or user account 302 independently from other administrators 324 or third party. User account 302 can be an integrated source of multiple transactions to which consumer 102 is a party, each of which can be stored in entry listing 304. Entry listing 304 can thereby include past entries in a state-specific lottery, previous transactions and issued prizes 322, and/or information and entries pertaining reward or incentive programs provided by administrator(s) 324. User account 302 can also include identifying information (e.g., usernames, passwords, etc.) pertaining to consumer 102 to provide a secure portal for using and/or accessing transaction agent 200 and account management system 300. In other embodiments, transacting agent 200 and/or account management system 300 can send a verification email or code to consumer 102, which can act to verify registration, detect fraud and/or request additional information from consumers 102.

Each supplier 326 can provide a product eligible for purchase, discount, and/or other exchange with consumer(s) 102 via reward generation program 202. Where applicable, each supplier 326 can be pre-registered and verified as a participant by having, e.g., a corresponding supplier profile 328 within reference data 204. Corresponding supplier profile(s) 328 can include, e.g., a listing of authorized and/or unauthorized products or coupons selectively made available to consumer(s) 102, such that each supplier 326 can control whether consumers 102 are able to receive products and/or coupons listed in one user inventory 312 and/or prize inventory 314. During operation of embodiments of the present disclosure, transacting agent 200 can send an automatic notification to supplier 326 indicating whether a particular consumer 102 has won a sweepstakes or simply redeemed one or more sweepstakes tokens 104. In response, supplier(s) 326 can manually or automatically tender prize(s) 322 to consumer 102 directly, and/or can instruct/authorize reward generation program 202 to issue prize(s) to consumer 102. In either case prize(s) 322 can include a product, a code or receipt capable of being exchanged for a tangible or intangible product, and/or a coupon or incentive for reducing the price of a desired item, e.g., within inventories 306.

Turning now to FIG. 2, an illustrative environment 400 for implementing the methods and/or systems described herein is shown. In particular, a computer system 402 is shown as including a computing device 106. Computing device 106 can include transacting agent 200, e.g., as a software component as discussed herein, or otherwise can be in communication with transacting agent as a stand-alone system or hardware implementation. Transacting agent 200 is described herein as being embodied as a software component solely for ease of illustration. Transacting agent 200 can include an embodiment of rewards generation program 202 therein for automatically generating sweepstakes rewards by performing any/all of the processes described herein and implementing any/all of the embodiments described herein.

Computer system 402 is shown including a processing unit 408 (e.g., one or more processors), an I/O component 410, a memory 412 (e.g., a storage hierarchy), an external storage system 414, an input/output (I/O) device 416 (e.g., one or more I/O interfaces and/or devices), and a communications pathway 418. In general, processing unit 408 can execute program code, such as transacting agent 200 and/or rewards generation program, either or both of which can at least partially fixed in memory 412. While executing program code, processing unit 408 can process data, which can result in reading and/or writing transformed data from/to memory 412 and/or I/O device 416. Pathway 418 provides a communications link between each of the components in environment 400. I/O component 410 can comprise one or more human I/O devices, which enable a human user to interact with computer system 402 and/or one or more communications devices to enable a system user to communicate with the computer system 402 using any type of communications link. To this extent, transacting agent 200 can manage a set of interfaces (e.g., graphical user interface(s), application program interface(s), etc.) that enable system users to interact with transacting agent 200 and/or rewards generation program 202, e.g., included therein. Further, transacting agent 200 can manage (e.g., store, retrieve, create, manipulate, organize, present, etc.) data, through several modules 420 contained rewards generation program 202 or elsewhere in memory 412.

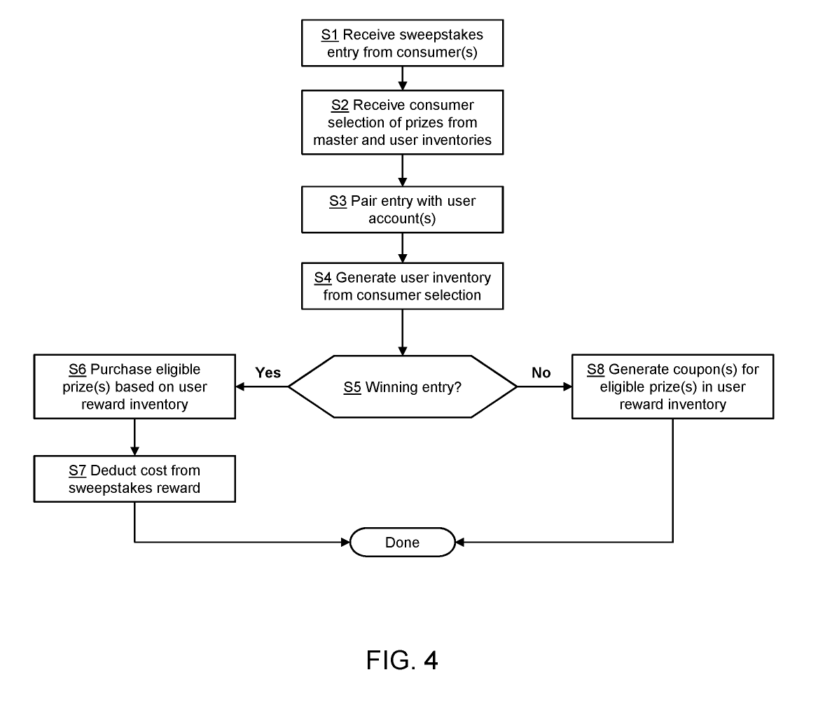

As discussed herein, rewards generation system 202 can be embodied as a software component of transacting agent 200. In this case, modules 420 can enable computer system 402 to perform a set of tasks used by rewards generation program 202, and can be separately developed and/or implemented apart from other portions of rewards generation program 202. Rewards generation program 202 can also include reference data 204 stored therewith, e.g., in memory 412. Computer system 402 can be operably connected to account management system 300 in order to access and/or copy user account(s) 302 or entry listing 304 therein. Account management system 300 and computer system 402 can be operatively to enable an exchange of signals or other information therebetween, and such that transacting agent 200 and/or account management system 300 can generate or select prize(s) 322 to be provided to consumer(s) 102 (FIG. 1). Process steps for automatically generating prize(s) 322 as sweepstakes rewards are discussed in detail elsewhere herein, e.g., by reference to the example process flow of FIG. 4.

Memory 412 can include various software modules 240 configured to perform different actions. Example modules can include, e.g., a comparator, a calculator, a list organizing/combining module, a determinator, etc. One or more modules 240 can use algorithm-based calculations, look up tables, software code, and/or similar tools stored in memory 412 for processing, analyzing, and operating on data to perform their respective functions. Each module discussed herein can obtain and/or operate on data from exterior components, units, systems, etc., or from memory 412 of computing device 404. Rewards generation program 202 can generate and/or modify reference data 204 to automatically generate a listing of sweepstakes rewards for consumer(s) 102 as described herein.

Where computer system 402 comprises multiple computing devices, each computing device may have only a portion of transacting agent 200 and/or rewards generation program 202 thereon (e.g., one or more modules). However, it is understood that computer system 402, account management system 300, transacting agent 200, etc., are only representative of various possible equivalent computer systems and components thereon that may perform a process described herein. Computer system 402 can obtain or provide data, such as data stored in memory 412 or storage system 414, using any solution. For example, computer system 402 can generate and/or be used to generate data from one or more data stores, receive data from another system, send data to another system, etc.

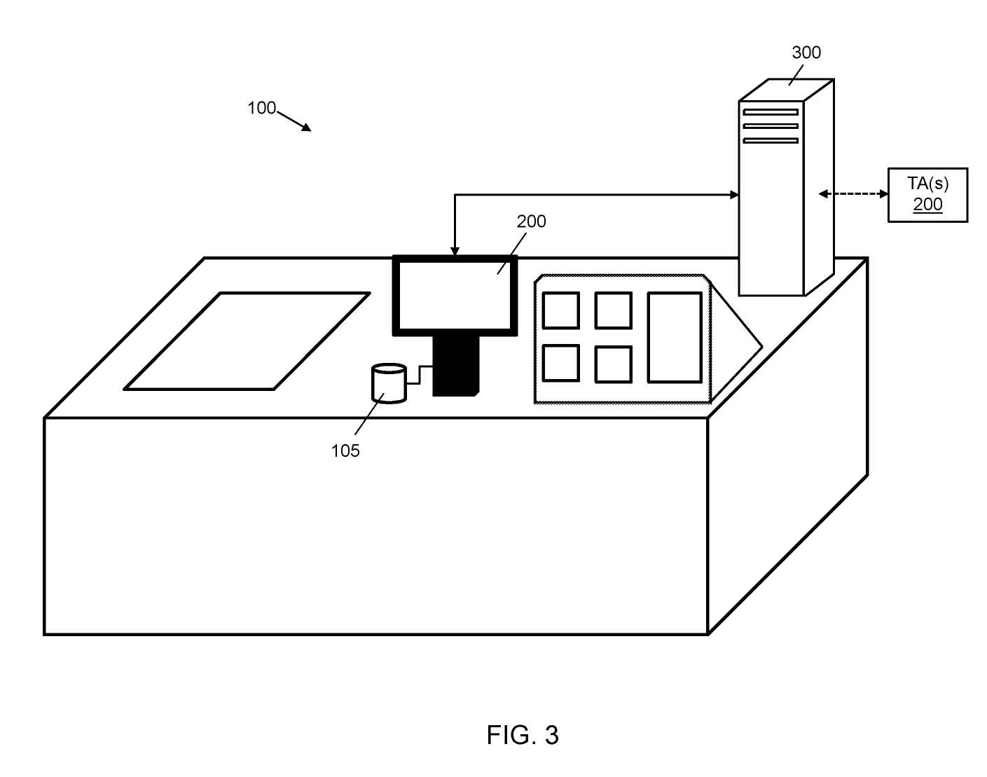

Turning to FIG. 3, an example embodiment of sweepstakes loyalty system 100, including transacting agent 200 and account management system 300, is shown. Here, transacting agent 200 can be embodied as or part of a physical kiosk including and/or operatively connected to reader 105 in the form of an optical scanner. Consumer(s) 102 (FIG. 1) can thereby submit token(s) 104 (FIG. 1) to reader 105 at, e.g., a retail point of service or other desk, such that transacting agent 200 can recognize token(s) 104. Thereafter, transacting agent 200 can transmit data pertaining to consumer(s) 102 and/or token(s) 104 to account management system 300, which as shown in FIG. 3 can be embodied as a separate component in communication with transacting agent 200 through any type of wired and/or wireless networking solution. It is also understood that account management system 300 can be provided as part of transacting agent 200. In addition, account management system 300 and/or transacting agent 200 can be in communication with other transacting agents (TA(s)) 200, e.g., in a networked computing and/or cloud computing environment. As such, it is understood that account management system 300 can receive token(s) 104 from one or more transacting agents 200 to implement embodiments of the present disclosure. It is also understood that transacting agent 200, as discussed herein, can be embodied as shown in FIG. 2, FIG. 3, and/or as a combination of both embodiments or in a configuration which includes all or portions of one or both example embodiments.

Referring to FIGS. 2 and 4 together, an illustrative flow diagram of methods according to the present disclosure is shown. The example method steps disclosed herein can be implemented, e.g., by software instructions encoded on or accessible to computer system 402 and one or more of the parts thereof discussed elsewhere herein. Although some of steps S1-S8 of FIG. 4 are shown as occurring in sequential order, it is understood that some of steps S1-S8 can be carried out in an alternative order where desired and applicable. It is further understood that one or more of the steps shown in FIG. 4 and discussed herein can be omitted where desired.

In step 51, transacting agent 200 (e.g., of computer system 402) can accept at least one sweepstakes token 104 (FIG. 1) submitted by consumer 102(s). In an example embodiment, consumer 102 can submit the sweepstakes token to a computer system 402 or a separately embodied transacting agent 200. The token submitted in step 51 can be a physical ticket or more broadly can include any physical or electronic item representing a single sweepstakes. In any case, the sweepstakes token can be received and, optionally, verified in step 51 by reference to a physical ticket, an electronic ticket (e.g., an electronically stored transaction record), a physical or electronic receipt, a ticket serial number, and/or other currently known or later developed processes for verifying a single transaction or sweepstakes token. Embodiments of the present disclosure can verify a sweepstakes by, e.g., using an optical scanner operated by consumer 102 and/or other parties to convert a particular ticket into an image which can be scanned for identifying information (ticket number, entry numbers, etc.).

At step S2, computer system 402 can receive a user selection of prizes from master inventory 308 (FIG. 1) and/or user inventories 312 (FIG. 1), including those of participating consumer 102 and/or other consumers 102 which can be stored, e.g., as reference data 204 (FIG. 1). As discussed elsewhere herein, user inventories 312 generated by the participating consumer 102 and/or other consumers 102 can be included as part of user account(s) 302 of account management system 300. Thus, the selection of products by consumer 102 can be previous to or simultaneous with step S2, based on the embodiments being implemented. The selection of products can include items offered via supplier(s) 326, directly through rewards generation program 202, and can include one or more prize(s) 322 selected and desired by consumer(s) 102 (e.g., coupons, tangible or intangible products, and/or combinations thereof). The selection of prizes 322 in step S2 can thus be performed with or without regard to whether some prize(s) 322 are provided in prize categories 310 or master inventories 312.

At step S3, modules 420 can pair the sweepstakes token(s) 104 (FIG. 1) of step Si with one or more corresponding user accounts 302, e.g., provided within account management system 300. The selection of desired products by created in step S2 can occur in conjunction with pairing sweepstakes tokens 104 with user account(s) 302 in step S3. More specifically user account 302 can be accessed and/or created subsequently to receiving a selection of prizes 322 from consumer(s) 102. Where user account 302 is newly created in step S3, steps S2 and S3 can occur substantially simultaneously with each other or in reverse order via modules 420 prompting consumer(s) 102 to input or select one or more products, e.g., from master inventory 308, user-generated or other user inventories 312, and creating user account 302 with this information included for future use. In some cases, user account 302 can include an incentive point value used with embodiments of the present disclosure and/or other systems interacting with account management system. To further incentive consumer(s) 102 to use embodiments of the present disclosure and/or other sweepstakes incentives programs, pairing user account 302 with one or more sweepstakes tokens 104 can include increasing a number of incentive points included with user account 302, to thereby incentivize further redemption of sweepstakes tokens 104. Consumers 102 can spend these accumulated incentive points e.g., in a marketplace included with reward generation program 202 or operated by other parties. In any event, modules 420 can locally save information within the paired user account(s) 304 within transacting agent 200 as part of step S3.

At step S4, modules 420 of rewards generation program 202 can generate a user inventory based on the consumer's selection of prizes S2 and/or selections and preferences stored in user account(s) 304. For example, the consumer selection of prizes received in step S2 may include prizes 322 not presently available from rewards generation program 202, some suppliers 326, and/or third party vendors. To accommodate this situation, content of user inventories 312 and/or the selection of prizes 322 can be prioritized, ranked, etc., to provide an ordered listing of which prizes 322 each consumer 102 desires most, and which prizes 322 each consumer 102 desires least. Consumer 102 can also mark some prizes 322 as not being desired, e.g., by not including them within the selection from step S2 or earmarking particular prizes 322 within user account 302 as not being desired as a prize.

Upon steps S1-S4 being completed, the flow can proceed to step S5 in which modules 420 can determine whether one or more consumers 102 have submitted a winning sweepstakes token 104. More specifically, modules 420 with determining functions can determine whether entry information provided with sweepstakes token 104 (e.g., a lottery entry number, ticket number or serial number, number selection by consumer 102, etc.) matches one or more winning values provided or stored within entry listing 304. Where one consumer 102 provides multiple sweepstakes tokens 104, and/or where user account 302 includes multiple sweepstakes tokens 104, it is understood that modules 420 can execute step S5 multiple times before proceeding to further process steps described herein. In addition, where some sweepstakes tokens 104 are considered “winning” entries (e.g., eligible for one or more rewards of any value, including cash rewards and/or other prizes) while other sweepstakes tokens 104 are not considered to be winning tokens (e.g., not capable of being redeemed for prizes 322 of any value), subsequent process steps S6-S7 and S8 can be executed substantially simultaneously. Alternatively, where only winning or non-winning sweepstakes tokens 104 are received in rewards generation program 202, only one of the process flows described herein can be executed.

Where modules 420 determine at least one sweepstakes token 102 to be a winning token (e.g., represented in entry listing 304 as winning to thereby trigger a “yes” at step S5), the flow can proceed to step S6 where rewards generation program 202 automatically purchases at least one eligible prize 322 from, e.g., administrator(s) 324, supplier(s) 326, and/or other parties. An eligible prize 322 is distinguished from other prizes 322, e.g., by being available for purchase to consumer(s) 102 who submit winning sweepstakes tokens 104. Where sweepstakes tokens 104 would otherwise be redeemable for a different reward (e.g., money, points in an account balance, etc.,) modules 420 in step S7 can deduct the cost of each issued prize 322 from a total monetary reward owed to consumer(s) 102 for submitting a winning sweepstakes token 104. As a result, embodiments of sweepstakes system 100 can receive winning token(s) 104 having a corresponding monetary reward value, and transform each token 104 into a different token 104 (or group thereof) which acts as, e.g., code redeemable for a product, a purchase order, a digital product, etc., along with a different monetary reward value. To provide this transformation, embodiments of sweepstakes system 100 can access and/or modify cloud computing resources such as user account(s) 302 to transform token(s) 104 initially provided to transacting agent 200 into other token(s) 104 including different system resources. The cost of each prize 322 need not be equivalent to a market price of the same good or service, and in some embodiments can be a discounted price offered specially or exclusively through transacting agent 200. Where the value of a winning sweepstakes token 104 is only partially exhausted to purchase prizes 322, modules 420 can deduct this cost from a total sweepstakes reward and provide the balance to consumer 102 as a separate prize 322, e.g., as cash or other redeemable balance. In addition or alternatively, the remaining money balance from a winning sweepstakes token 104 can be credited to user account 304, such that consumer 102 can manually order desired prize(s) 322 when they are made available, or rewards generation program 202 can automatically order desired prizes 322 when they are made available or when a sufficient balance is accumulated in user account 302.

In some cases, modules 420 can identify at least one sweepstakes token 104 as being non-winning (e.g., not corresponding to at least one win scenario provided in entry listing 304, thereby yielding a “no” at step S5). Here, the flow can proceed to step S8 of generating one or more coupons for consumer(s) 102 as a type of prize 322. Each coupon can be generated internally by rewards generation program 202 (e.g., of transacting agent 200), and/or externally by administrator(s) 324, supplier(s) 326, or other parties. In any event, each coupon can correspond to at least one prize or category identified in the consumer selection of prizes received by rewards generation program in step S2. Where the selection of prizes received in step S2 does not include prizes for which one or more coupons are available, modules 420 can identify products and/or prize categories 310 in the selection of prizes 322 in prize inventory 314 to generate coupons for related goods or services as a prize for consumer(s) 102. As discussed elsewhere herein, the coupons generated in step S8 can include physical and/or digital coupons, which can generally include any type of discount, purchase incentive, reduction in price, etc. Thus, step S8 can allow modules 420 of rewards generation program 202 to provide special offers and rewards to consumer(s) 102 who tender non-winning sweepstakes tokens 104. As a result of receiving coupons generated in step S8, consumer(s) 102 may be motivated to seek or purchase additional sweepstakes tokens 104 with the expectation of receiving prizes 322 for both winning and non-winning sweepstakes tokens 104. In addition, it is understood that coupons may be generated for only some non-winning sweepstakes tokens 104, e.g., where consumers 102 furnish sweepstakes entries above a threshold value, achieve a threshold number of sweepstakes entries in user account 302, etc.

The various embodiments discussed throughout the present disclosure can offer several technical commercial advantages, some of which are provided as illustrative examples herein. For instance, consumer(s) 102 with user account 302 and access to transacting agent 200 can have additional motivation to obtain and furnish sweepstakes tokens 104 with the expectation of receiving customized prizes 322 based on their individual interests. Where consumer(s) 102 do not win a particular sweepstakes, consumer(s) 102 can nevertheless benefit by receiving prizes 322 in the form of coupons for goods or services applicable to their interests as defined in user account 302. In addition, embodiments of the present disclosure provide a social network and/or private forum for viewing sponsored listings of prizes and/or inventories created by other users, such that each consumer 102 can generate and/or browse inventories 306 to input and/or discover various products in which they would desire as prizes 322 in a particular sweepstakes. Embodiments of the present disclosure can also provide for machine learning, e.g., by analyzing prize inventories 314 of the participating consumer(s) 102 and/or other consumers 102 to find shared interests, to suggest new prizes 322 for consumers 102 to add to their inventories 306, and to transmit some types of information in inventories 306 and/or account management system 300 to administrators 324 or suppliers 326 to improve marketing and/or customer relations management.

Regardless, when computer system 400 includes multiple computing devices, the computing devices can communicate over any type of communications link. Further, while performing a process described herein, computer system 400 can communicate with one or more other computer systems using any type of communications link. In either case, the communications link can comprise any combination of various types of optical fiber, wired, and/or wireless links; comprise any combination of one or more types of networks; and/or utilize any combination of various types of transmission techniques and protocols.

While shown and described herein as a method and system for sending and receiving encrypted messages, it is understood that aspects of the invention further provide various alternative embodiments. For example, in one embodiment, the invention provides a computer program fixed in at least one computer-readable medium, which when executed, enables a computer system to send and receive encrypted messages. To this extent, the computer-readable medium includes program code, such as rewards generation program 202, which implements some or all of a process described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; paper; and/or the like.

In another embodiment, the invention provides a method of providing a copy of program code, such as rewards generation program 202, which implements some or all of a process described herein. In this case, a computer system can process a copy of program code that implements some or all of a process described herein to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of generating a system for creating and accessing transacting agent 200 (e.g., with rewards generation program 202 therein) and/or account management system 300. In this case, a computer system, such as computer system 400, can be obtained (e.g., created, maintained, made available, etc.) and one or more components for performing a process described herein can be obtained (e.g., created, purchased, used, modified, etc.) and deployed to the computer system. To this extent, the deployment can comprise one or more of: (1) installing program code on a computing device; (2) adding one or more computing and/or I/O devices to the computer system; (3) incorporating and/or modifying the computer system to enable it to perform a process described herein; and/or the like.

Aspects of the invention can be implemented as part of a business method that performs a process described herein on a subscription, advertising, and/or fee basis. That is, a service provider could offer to send and receive encrypted messages as described herein. In this case, the service provider can manage (e.g., create, maintain, support, etc.) a computer system, such as computer system 400, that performs a process described herein for one or more customers. In return, the service provider can receive payment from the customer(s) under a subscription and/or fee agreement; receive payment from the sale of advertising to one or more third parties, and/or the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A computer-implemented method for automatically generating a sweepstakes reward, the method comprising:
pairing a sweepstakes token with a user profile stored in an electronic data processing system operated by an administrator independent from a sweepstakes administrator;
generating a user prize inventory for the user profile using a selection of prizes from a master inventory, a user-generated inventory, and an inventory of a different user profile;
in response to the sweepstakes token being a winning token, purchasing at least one eligible prize from the user prize inventory and deducting a cost of the at least one eligible prize from a sweepstakes monetary reward; and
in response to the sweepstakes token being a non-winning token, generating at least one coupon for an eligible prize based on the user prize inventory.

2. The method of claim 1, wherein the at least one coupon corresponds to an item category in the user prize inventory, and does not correspond to a specific item therein.

3. The method of claim 1, wherein the cost of the at least one eligible prize comprises a different cost relative to an advertised retail price of the at least one eligible prize.

4. The method of claim 1, wherein the pairing of the sweepstakes token with the user profile further includes verifying the sweepstakes token and verifying an association between the user profile and a sweepstakes transaction.

5. The method of claim 1, wherein the sweepstakes includes one of a state-operated lottery and a retailer-operated lottery, and wherein the user account is independent of the state-operated lottery and the retailer-operated lottery.

6. The method of claim 1, further comprising increasing an incentive point value of the user profile after the pairing of the sweepstakes token with the user profile.

7. The method of claim 1, wherein the at least one eligible prize is purchased from one of a plurality of suppliers having a supplier profile stored in the electronic data processing system.

8. A program product stored on a computer readable storage medium, the program product operable to automatically generate a sweepstakes reward when executed, the computer readable storage medium comprising program code for:
pairing a sweepstakes token with a user profile stored in an electronic data processing system operated by an administrator independent from a sweepstakes administrator;
generating a user prize inventory for the user profile using a selection of prizes from a master inventory, a user-generated inventory, and an inventory of a different user profile;
in response to the sweepstakes token being a winning token, purchasing at least one eligible prize from the user prize inventory and deducting a cost of the at least one eligible prize from a sweepstakes monetary reward; and
in response to the sweepstakes token being a non-winning token, generating at least one coupon for an eligible prize based on the user prize inventory.

9. The program product of claim 8, wherein the at least one coupon corresponds to an item category in the user prize inventory, and does not correspond to a specific item therein.

10. The program product of claim 8, wherein the cost of the at least one eligible prize comprises a different cost relative to an advertised retail price of the at least one eligible prize.

11. The program product of claim 8, wherein the pairing of the sweepstakes token with the user profile further includes verifying the sweepstakes token and verifying an association between the user profile and a sweepstakes transaction.

12. The program product of claim 8, wherein the sweepstakes includes one of a state-operated lottery and a retailer-operated lottery, and wherein the user account is independent of the state-operated lottery and the retailer-operated lottery.

13. The program product of claim 8, further comprising program code for increasing an incentive point value of the user profile after the pairing of the sweepstakes token with the user profile.

14. The program product of claim 8, wherein the at least one eligible prize is purchased from one of a plurality of suppliers having a supplier profile stored in the electronic data processing system.

15. A system for automatically generating a sweepstakes reward, the system comprising:
an account management system for pairing a sweepstakes token with a user profile stored in an electronic data processing system operated by an administrator independent from a sweepstakes administrator; and
a transacting agent including program code for:
generating a user prize inventory for the user profile using a selection of prizes from a master inventory, a user-generated inventory, and an inventory of a different user profile,
in response to the sweepstakes token being a winning token, purchasing at least one eligible prize from the user prize inventory and deducting a cost of the at least one eligible prize from a sweepstakes monetary reward, and
in response to the sweepstakes token being a non-winning token, generating at least one coupon for an eligible prize based on the user prize inventory.

16. The system of claim 15, wherein the at least one coupon corresponds to an item category in the user prize inventory, and does not correspond to a specific item therein.

17. The system of claim 15, wherein the cost of the at least one eligible prize comprises a different cost relative to an advertised retail price of the at least one eligible prize.

18. The system of claim 15, wherein the pairing of the sweepstakes token with the user profile further includes verifying the sweepstakes token and verifying an association between the user profile and a sweepstakes transaction.

19. The system of claim 15, wherein the sweepstakes includes one of a state-operated lottery and a retailer-operated lottery, and wherein the user account is independent of the state-operated lottery and the retailer-operated lottery.

20. The system of claim 15, wherein the account management system is further configured to increase an incentive point value of the user profile after the pairing of the sweepstakes token with the user profile.

21. The system of claim 15, wherein the transacting agent purchases the at least one eligible prize from one of a plurality of suppliers having a supplier profile stored in the electronic data processing system.
